(19) United States
(12) Patent Application Publication
(10) Pub. No.: US 2008/0164394 A1
(43) Pub. Date: Jul. 10, 2008

(54) ELECTRICAL CONTROLS BRACKET

(75) Inventors: Tabraiz Ali Khan, Wichita, KS (US); Paul Lucas, Douglass, KS (US)

Correspondence Address: MCNEES WALLACE & NURICK LLC, 100 PINE ST., P.O. BOX 1166, HARRISBURG, PA, 17108-1166, US

(73) Assignee: JOHNSON CONTROLS TECHNOLOGY COMPANY, Holland, MI (US)

(21) Appl. No.: 11/971,528

(22) Filed: Jan. 9, 2008

Related U.S. Application Data
(60) Provisional application No. 60/884,261, filed on Jan. 10, 2007.

(51) Int. Cl. F16M 13/00

(52) U.S. Cl. 248/274.1

(57) ABSTRACT

A furnace system is provided having a bracket. The bracket is configured to permit a component panel to be moved from a mounting position within the HVAC housing to a servicing position outside the HVAC housing for easier access during initial set up, maintenance and repairs.

### CROSS REFERENCE TO RELATED PATENT APPLICATIONS

This application claims the benefit of U.S. Provisional Application No. 60/884,261, filed Jan. 10, 2007.

### BACKGROUND

The present application relates generally to brackets for a furnace system.

The basic components of a furnace system are: a burner, a heat exchanger, an air distribution system, and a vent pipe. In the burner, gas (natural or propane) or oil is delivered and burned to generate heat. The heat exchanger transfers the heat from the gasses of combustion to the air distribution system. The air distribution system, which includes a blower and ductwork, delivers the heated air throughout the home and returns cooler air to the furnace to be heated. Finally, the vent pipe or flue exhausts byproducts of combustion (such as water vapor and carbon dioxide) outside of the home. In addition, the furnace system may also include a cooling element, such as an A-coil, that operates in conjunction with an air conditioning unit (typically located outside of the home) to provide cooled air to the home instead of heated air.

Typically, furnace systems in residential applications are located in the basement or a small closet in the user's home, which areas have limited space for an installed furnace system. Furthermore, efficiency standards have recently changed, thereby requiring the size of the A-coil to be increased to meet these new standards. Thus, when a newer furnace system is needed to replace an older system, often, the newer furnace can not fit into the space where the old furnace was installed because the size of the furnace unit and the newer, taller A-coil that is required is greater than the available installation space. Thus, a shorter, furnace is needed to accommodate the taller A-coil in order to be able to install a new furnace system in the same space as the old furnace system.

In addition, HVAC systems require periodic maintenance and/or repairs to ensure proper operation. Most common residential systems are installed in a basement area, or dimly lit closet space, making it difficult for a service person to perform the maintenance or repairs. Further, the service person is most often accessing the control panel, which is mounted vertically inside the HVAC enclosure, requiring the service person to have to kneel, sit, or lay on the floor to access. What is needed is a system or method for providing a more user-friendly control panel for accessing during maintenance and repairs.

Intended advantages of the disclosed systems and/or methods satisfy one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY

An HVAC unit is set forth having a housing, an electrical component for the HVAC unit disposed in the housing and a plate configured and disposed to mount the electrical component. The HVAC unit also has a bracket disposed within the housing to connect the plate to the housing. The bracket has a hinge configured to permit the plate to move relative to the housing. The hinge of the bracket is configured to permit the plate to move between a first position disposed inside the housing and a second position disposed outside the housing, the positioning of the plate in the second position provides access to the electrical component.

A mounted panel is set forth having a plate configured and disposed to mount at least one electrical component, and a bracket disposed within a housing to connect the plate to the housing. The bracket has a hinge configured to permit the plate to move relative to the housing. The hinge of the bracket is configured to permit the plate to move between a first position disposed inside the housing and a second position disposed outside the housing, the positioning of the plate in the second position provides access to the at least one electrical component.

One advantage is that the bracket provides user-friendly accessibility to the control panel of an HVAC system.

Other features and advantages will be apparent from the following more detailed description of the embodiments, taken in conjunction with the accompanying drawings which illustrate, by way of example, the principles of the application.

### BRIEF DESCRIPTION OF THE DRAWINGS

FIG. 1 is an illustration of an exemplary HVAC system disposed in a residential setting.

FIG. 2 is a partially exploded view of an exemplary HVAC system according to an exemplary embodiment of the disclosure.

FIG. 3 is a schematic arrangement of a HVAC system according to an embodiment of the disclosure.

FIG. 4 is an illustration of the bracket as disposed in the HVAC system in the mounting position.

FIG. 5 is an illustration of the bracket in the servicing position as disposed in the HVAC system.

FIG. 6 is a side view of the bracket in the mounting position.

FIG. 7 is a side view of the bracket in the servicing position.

### DETAILED DESCRIPTION

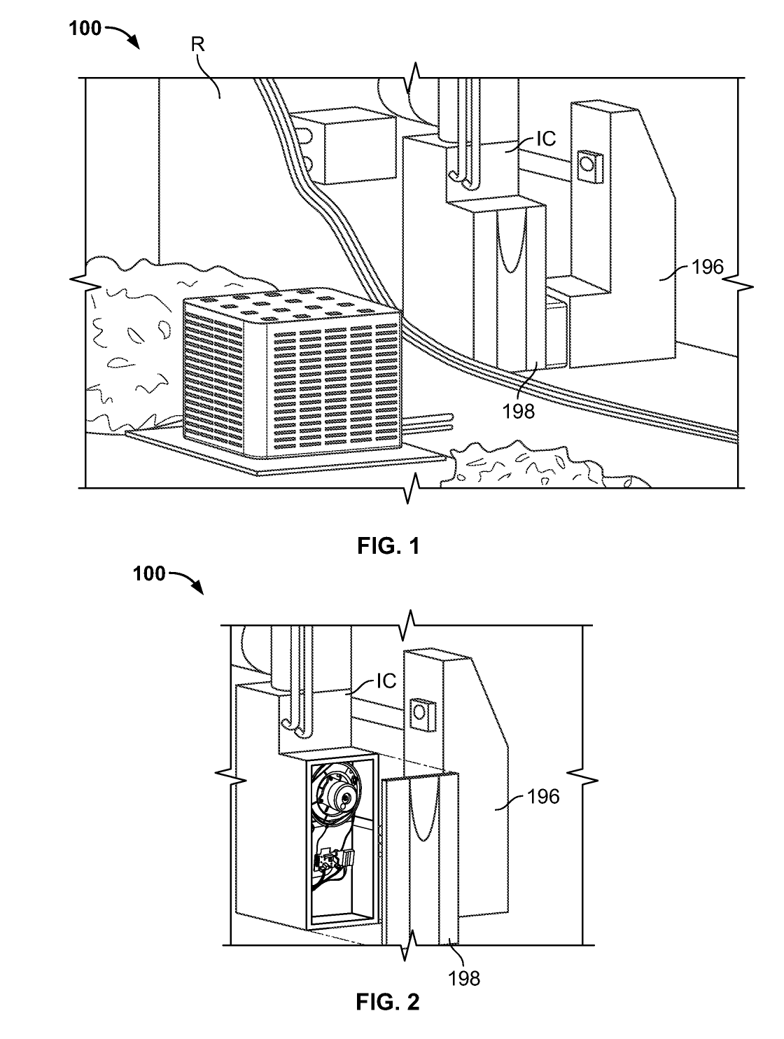

FIG. 1 shows an exemplary furnace or HVAC or furnace system 100 in a typical residential setting R. Further, FIG. 2 illustrates an exemplary HVAC or furnace system 100 having a housing with a door panel 198. The door panel 198 allows access to the internal portion of the furnace system 100.

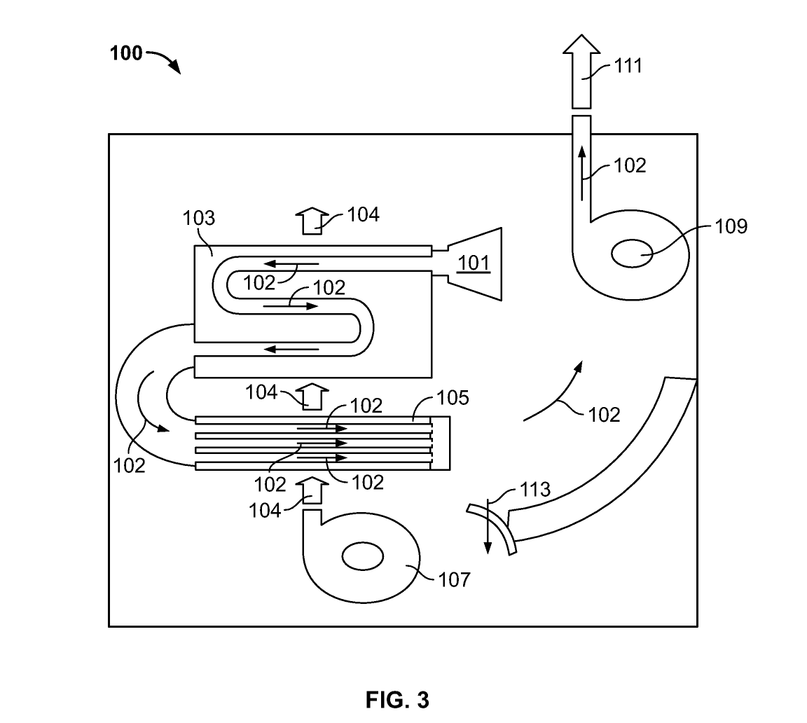

FIG. 3 shows a schematic arrangement of the components of a furnace system 100. During operation, a burner 101 combusts fuel with combustion air 102 and provides combustion products and heated air to a first heat exchanger 103, where heat is transferred to a supply air 104. Supply air 104 is air that is to be heated, such as interior air for a building HVAC system. Combustion air 102 is then directed into a second heat exchanger 105, where heat is exchanged with supply air 104. Supply air 104 is directed over first heat exchanger 103 and second heat exchanger 105 by use of a blower 107 or similar air-moving device. Combustion air 102 is then exhausted from the system by use of an exhaust blower 109 or other air-moving device. Exhaust 111 includes combustion air, water vapor and other combustion products. Furnace system 100 provides heat to supply air 104 by use of first heat exchanger 103 and second heat exchanger 105. Supply air 104 is than provided to a space for heating.

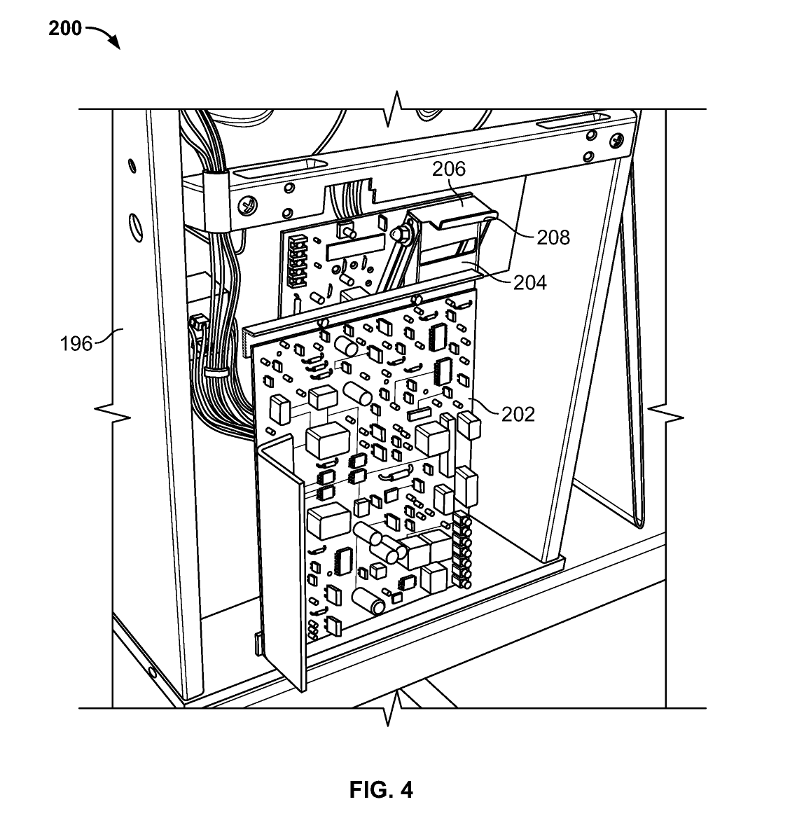

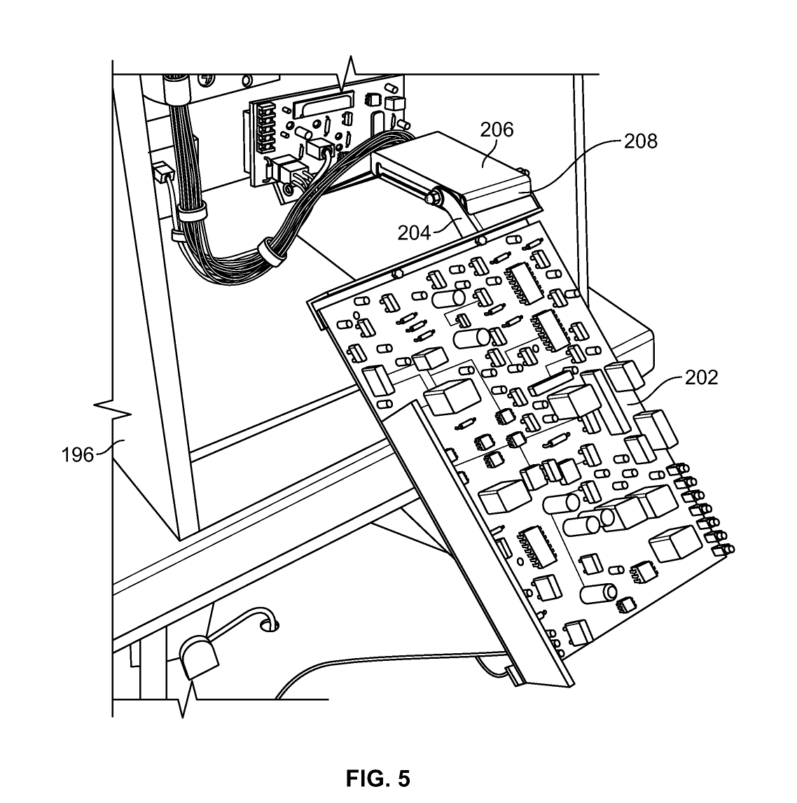

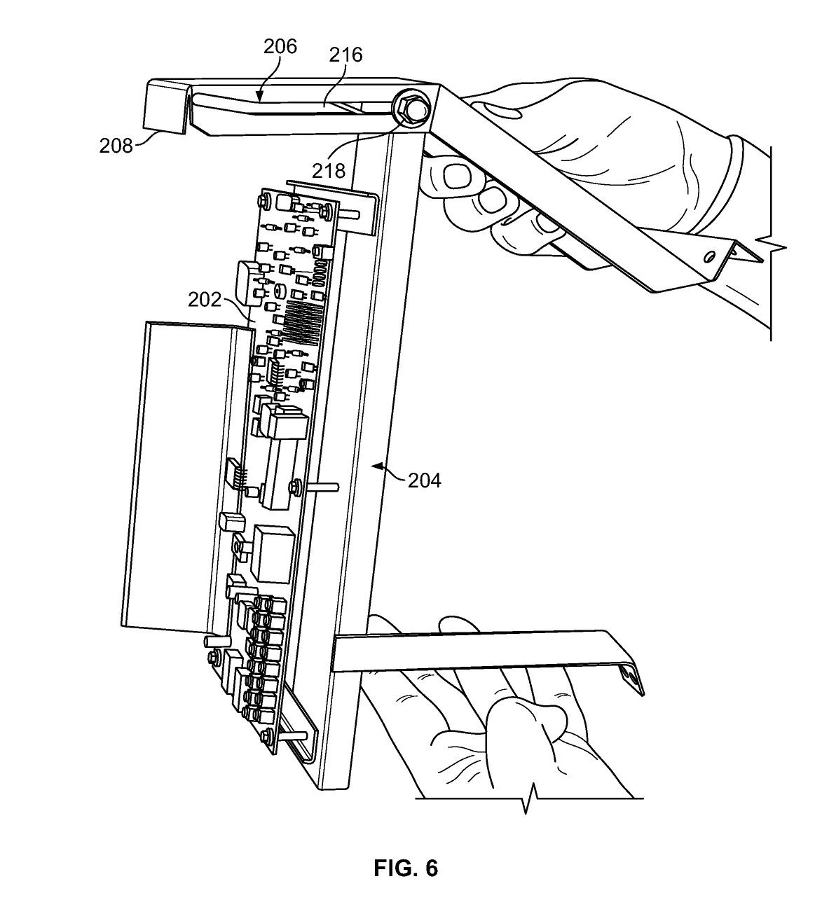

Referring now to FIGS. 4 and 5, bracket 200 is used for mounting electrical components 202 on component panel 204 and providing easy access to the components 202 by a user. In addition, the bracket 200 is configured to move the component panel 204 from a mounted position inside the HVAC housing 196 (as shown in FIG. 4) to a servicing position (as shown in FIG. 5) outside the HVAC housing 196. The bracket 200 also moves or positions the component panel 204 to any preselected angle position between the mounted position and the servicing position to facilitate repairs or any work required on the component panel 204. The component panel 204 is in the mounted position when the component panel 204 is not being accessed, and during normal operation of the HVAC system 100. The component panel 204 is moved to the servicing position outside of the HVAC housing 196 when maintenance or service is required and/or when access to the component panel 204 is necessary.

The bracket 200 has a pivoting, hinging, or other suitable hinging mechanism 206 attached to one end of the bracket 200. The hinging mechanism 206 permits the bracket 200 to move between the mounted and servicing positions when a force is applied by a user. When the bracket 200 is placed in the mounted position, the bracket 200 does not move to the servicing position until the user desires and applies a force to move the bracket 200 to the servicing position. Likewise, once the bracket 200 is placed in the servicing position, the bracket 200 does not move to the mounted position until the user desires and applies a force to move the bracket 200 to the mounted position.

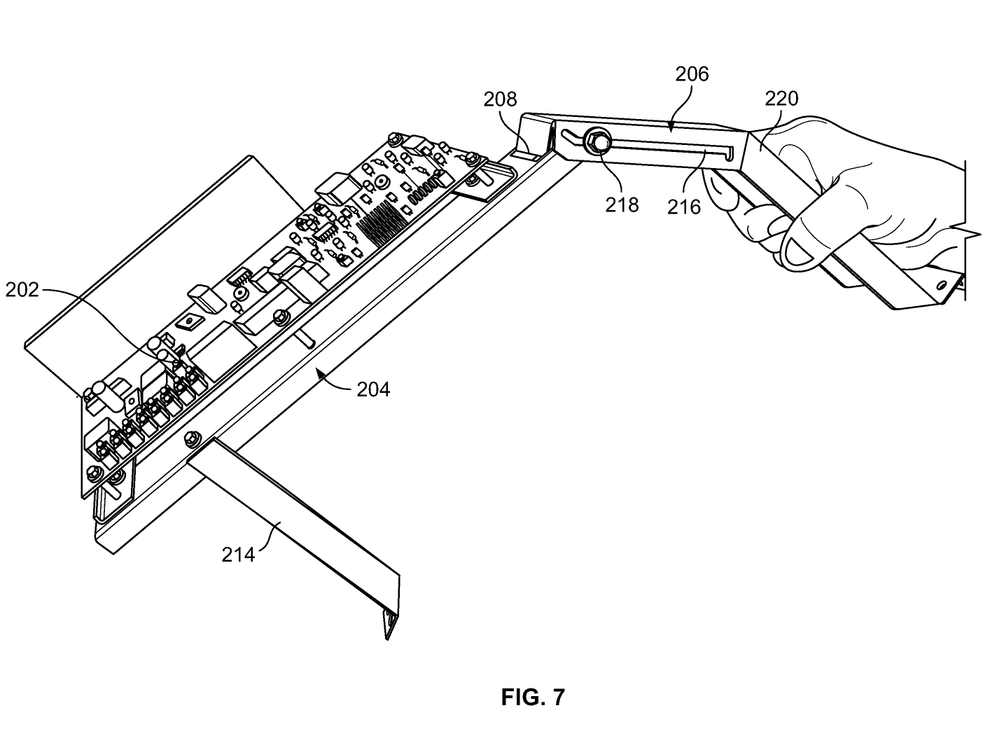

FIGS. 6 and 7 illustrate a side view of the bracket 200 in the mounted position (FIG. 6) and in position at a preselected angle between the mounted position and the servicing position (FIG. 7). Referring specifically to FIG. 6, the bracket 200 has a path or slot 216 in which a pin 218 or other suitable bearing device moves within. The component panel 204 is attached to the pin 218, to allow the component panel 204 to move forward and backward along the path 216 for easier access by a user. When the bracket 200 is in the mounted position, the pin 218 and component panel 204 are disposed at the far end of the slot 216, closest to the mounting bars 220, and the component panel 204 is substantially perpendicular to the bracket 200. While FIG. 6 illustrates the component panel 204 substantially perpendicular to the bracket 200, it is known by those skilled in the art that component panel 204 may be disposed at any suitable angle to the bracket 200 when the component panel 204 is in the mounted position.

Referring now specifically to FIG. 7, the bracket 200 is in the servicing position, and the component panel 204 is now extended outward and away from the mounting bars 220. The pin 218 is now disposed near the opposite end of the slot 216, furthest from the mounting bars 220 and the component panel 204 is at a substantially 45 degree angle to the bracket 200. While FIG. 7 illustrates the control panel 204 substantially 45 degrees to the bracket 200, it is known by those skilled in the art that the component panel 204 may be disposed at any preselected angle while in the servicing position.

In an alternate exemplary embodiment, the pivoting or hinging mechanism 206 may incorporate a locking mechanism 208 that permits the bracket 200 to be held in the servicing position while being worked on by a user. The locking mechanism 208 prevents the component panel 204 from moving from a position once the user has locked the component panel 204 in place. Even with a force applied by a user, the component panel 204 will not move into the servicing position from the mounted position, or move from the mounted position to the servicing position, or any position in between when the locking mechanism is engaged.

In another exemplary embodiment, the bracket 200 has a mounting plate 204, e.g., a metal plate, that is used for the mounting of electrical components 202. Finally, to provide extra support to the mounting plate 212 and bracket 200, a mounting bracket 214 may be used to secure the end of the bracket 200 and/or mounting plate 212 opposite the hinging mechanism 206 to the furnace housing 196.

To move the bracket 200 from the mounted position to the servicing position either the mounting bracket 214 has to be disconnected from the housing 196 or configured to permit the movement of the end of the bracket 200 or mounting plate 212 to the servicing position.

While the systems and/or methods of the application have been described with reference to several embodiments, it will be understood by those skilled in the art that various changes may be made and equivalents may be substituted for elements thereof without departing from the scope of the application. In addition, many modifications may be made to adapt a particular situation or material to the teachings of the application without departing from the essential scope thereof. Therefore, it is intended that the application not be limited to the particular embodiment disclosed as the best mode contemplated for carrying out the systems and/or methods of the application, but that the application will include all embodiments falling within the scope of the appended claims.

What is claimed is:

1. An HVAC unit comprising:
a housing;
an electrical component for the HVAC unit disposed in the housing;
a plate configured and disposed to mount the electrical component;
a bracket disposed within the housing to connect the plate to the housing, the bracket having a hinge configured to permit the plate to move relative to the housing; and wherein the hinge of the bracket is configured to permit the plate to move between a first position disposed inside the housing and a second position disposed outside the housing, the positioning of the plate in the second position provides access to the electrical component.

2. The HVAC unit of claim 1 wherein the hinging mechanism further comprises a slot extending through the bracket and a pin extending through the slot.

3. The HVAC unit of claim 1 wherein the plate is substantially perpendicular to the bracket when the bracket is in the first position.

4. The HVAC unit of claim 1 wherein the plate is disposed at a preselected angle from the vertical when the bracket is in the second position.

5. The HVAC unit of claim 1 wherein application of force to the bracket moves it from the first position to the second position.

6. The HVAC unit of claim 1 wherein the bracket is rotatable about the hinging mechanism between the first and second positions.

7. The HVAC unit of claim 1 further comprises a locking mechanism, wherein the locking mechanism prevents movement of the bracket when the locking mechanism is in an engaged position.

8. The HVAC unit of claim 7 wherein the first position is a mounted position, further including a plurality of servicing positions between the mounted position and the second position and wherein the locking mechanism prevents movement of the bracket when the locking mechanism is in the engaged position and the bracket is positioned in one of the plurality of servicing positions.

9. A mounted panel comprising:
a plate configured and disposed to mount at least one electrical component;
a bracket disposed within a housing to connect the plate to the housing, the bracket having a hinge configured to permit the plate to move relative to the housing; and wherein the hinge of the bracket is configured to permit the plate to move between a first position disposed inside the housing and a second position disposed outside the housing, the positioning of the plate in the second position provides access to the at least one electrical component.

10. The mounted panel of claim 9 wherein the hinging mechanism further comprises a slot extending through the bracket and a pin extending through the slot.

11. The mounted panel of claim 9 wherein the plate is substantially perpendicular to the bracket when the bracket is in the first position.

12. The mounted panel of claim 9 wherein the plate is disposed at a preselected angle from the vertical when the bracket is in the second position.

13. The mounted panel of claim 9 wherein application of force to the bracket moves it from the first position to the second position.

14. The mounted panel of claim 9 wherein the bracket is rotatable about the hinging mechanism between the first and second positions.

15. The mounted panel of claim 9 further comprises a locking mechanism, wherein the locking mechanism prevents movement of the bracket when the locking mechanism is in an engaged position.

16. The mounted panel of claim 15 wherein the first position is a mounted position, further including a plurality of servicing positions between the mounted position and the second position and wherein the locking mechanism prevents movement of the bracket when the locking mechanism is in the engaged position and the bracket is positioned in one of the plurality of servicing positions.
